(19) United States
(12) Patent Application Publication
(10) Pub. No.: US 2013/0284106 A1
(43) Pub. Date: Oct. 31, 2013

(54) VIVARIUM WALL DEVICE SYSTEM

(71) Applicant: Richard P. Moewe, Fairfield, CT (US)

(72) Inventor: Richard P. Moewe, Fairfield, CT (US)

(21) Appl. No.: 13/855,376

(22) Filed: Apr. 2, 2013

Related U.S. Application Data
(60) Provisional application No. 61/620,133, filed on Apr. 4, 2012.

(51) Int. Cl. A01K 63/00

(52) U.S. Cl. CPC A01K 63/006
USPC 119/253

(57) ABSTRACT

A vivarium wall device system comprising: a piece of coral or a piece of wood, the piece having a glass-side surface, upper surface, lower surface, and three side surfaces, and where the glass-side surface is generally flat and regular; a vivarium wall attachment means comprising: a first inside magnet, generally permanently attached to the glass-side surface; a first outside magnet, configured to be removeably and magnetically attachable to the first inside magnet; where when the first inside magnet is configured to be located inside the vivarium and magnetically attach to a first outside magnet located outside of the vivarium, and where the magnetic attraction occurs across a vivarium wall, and the coefficient of friction of the vivarium wall and the magnetic force tend to hold the piece of coral in place on the vivarium wall.

### CROSS-REFERENCES

This patent application claims the benefit of provisional patent application No. 661/620,133 to Richard P. Moewe, entitled “Coral Shelf System”, filed on Apr. 4, 2012, and which provisional application is fully incorporated by reference herein.

### TECHNICAL FIELD

This invention relates to vivariums for displaying or exhibiting animals, and more particularly, to a vivarium wall device system that can be attached to a wall of the vivarium.

### BACKGROUND

Vivariums include terrariums and aquariums. Aquariums are generally four sided glass tanks which are filled with water and used to display fish, crustaceans, and other aquatic life. It is not uncommon for an aquarium to have rocks and rock formations, tree branches, and other decorative artifacts placed on the bottom of tank for the marine life to move around, through and about. If there is a substantial volume of this material, it will not only cover the bottom of the tank but do so to a depth that the material starts to cover the bottom portion of the sidewalls of the aquarium as well. It sometimes may be desirable, for the overall appearance of the aquarium, to attach an object to an inside wall of the tank at a level above that of the other material placed in the tank. Heretofore, that has been difficult to do. For example, an artifact could be taped or glued to the wall of the tank, but this requires draining the tank and refilling it. In addition, prolonged submersion in the water may cause the glue or tape to lose its adhesiveness, causing the object to dislodge. A hole could be drilled through the sidewall of the aquarium to allow the object to be set in place using a screw or the like. This again requires draining and refilling of the tank, in addition to providing a waterproof seal about the hole. If the object is later removed, the hole must be filled which may leave an unsightly appearance.

In addition, it has been difficult to attach any sort of shelf or shelves to the walls of an aquarium.

In addition, similar problems for attaching shelves or other items to terrariums and vivariums in general are known.

Thus, there is a need for a system that can overcome the above and other limitations.

### SUMMARY OF THE INVENTION

The disclosed invention relates to a vivarium wall device system comprising: a piece of coral, the piece of coral having a glass-side surface, upper surface, lower surface, and three side surfaces, and where the glass-side surface is generally flat and regular; a vivarium wall attachment means comprising: a first inside magnet, generally permanently attached to the glass-side surface; a first outside magnet, configured to be removeably and magnetically attachable to the first inside magnet; where when the first inside magnet is configured to be located inside the vivarium and magnetically attach to a first outside magnet located outside of the vivarium, and where the magnetic attraction occurs across a vivarium wall, and the coefficient of friction of the vivarium wall and the magnetic force tend to hold the piece of coral in place on the vivarium wall.

The disclosed invention also relates to a vivarium wall device system comprising: a wood piece, the wood piece having a glass-side; a vivarium wall attachment means comprising: a first inside magnet, generally permanently attached to the glass-side; a first outside magnet, configured to be removeably and magnetically attachable to the first inside magnet; where when the first inside magnet is configured to be located inside the vivarium and magnetically attach to a first outside magnet located outside of the vivarium, and where the magnetic attraction occurs across a vivarium wall, and the coefficient of friction of the vivarium wall and the magnetic force tend to hold the wood piece in place on the vivarium wall.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a cross-sectional view of the vivarium wall device system;

FIG. 2 is a perspective view showing the vivarium wall device system installed on an vivarium wall;

FIG. 3 is a side view of another embodiment of the vivarium wall device system; and

FIG. 4 is a cross-sectional view of a wood embodiment of the vivarium wall device system.

### DETAILED DESCRIPTION

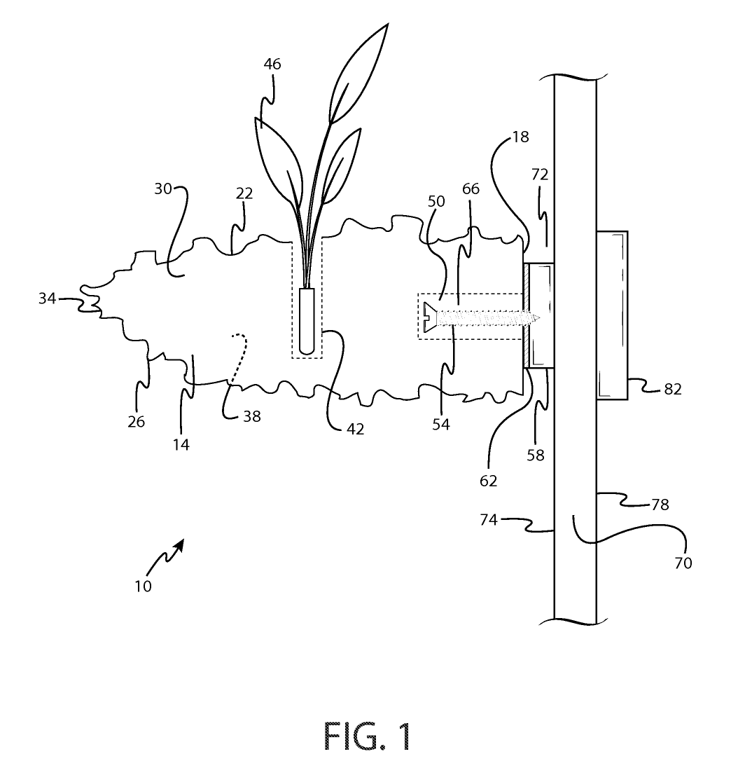

FIG. 1 is a cross-sectional view of one embodiment of the disclosed vivarium wall device system 10. A natural piece of coral 14 comprises the shelf section of the system. The coral 114 may be naturally shaped on all but the glass-side surface 18 that is that all other sides of the coral may retain its natural shape. The glass-side 18 of the coral will be cut or machined to a flat surface. The coral 14 may also be cut to form a generally “shelf” shape, with an upper surface 22, lower surface 26, and three side surfaces 30, 34, 38 in addition to the glass-side 18 surface. The upper surface 22, lower surface 26, and three side surfaces 30, 34, 38 may be relatively flat and uniform having a generally man-made shelf shape, or in other embodiments, the coral 14 may have a very irregular shape, such as may occur in nature with coral. The coral may be any suitable coral rock, including but not limited to BRS Pukani Dry Eco Aquarium Live Rock sold by Bulk Reef Supply, 672 Mendelssohn Avenue North, Golden Valley, Minn. 55427, pukani rock, or live rock. The coral 14 may have one or more holes 42 cut into the upper surface 22. These holes 42 may be used to receive a plant plug 46. In one embodiment the plant plugs 46 may be inserted into the hole 42 so that plant 46 generally grows out of the top upper surface 22. In other embodiments, the plant 46 may grow out of any of the upper surface 22, lower surface 26, and three side surfaces 30, 34, 38. One or more holes 50 are cut into the glass-side surface 18. In each hole 50 is an attachment means 54, which include but are not limited to threaded members, threaded screws, non-ferrous threaded members, non-ferrous screws. The attachment means 54 may be held in place in the hole 50 by a marine epoxy 66 or glue. A magnet 58 is attached to each attachment means 54 by mechanically screwing the attachment means 54 partially into magnet 58, In this arrangement, the surface of the coral 14 does not touch the vivarium wall 70, thus preventing scratching and other damage to the vivarium wall 70. In addition there is gap 72 between the glass-side 18 of the coral and the inner side 74 of the wall. This gap 72 allows for circulation of water on all sides of the coral 14, thereby allowing for natural growth conditions on and around the coral. In another embodiment, there is a marine glue 62 62 used to assist in attaching the magnet 58 to the glass side surface 18. The marine glue 62 may be configured to adhere to rubber. A vivarium wall 70 is shown. The vivarium wall 70 will have an inner side 74, that faces the interior of the vivarium, and an outer side 78 that faces outside of the vivarium. Another set of magnets 82 are configured to be magnetically attracted to magnets 58. Thus, the coral 14 can be held against the vivarium wall 70 due to the magnetic forces of magnets 58 and 82, and the coefficient of friction between the magnets 58, 82 and the vivarium wall 70. The magnets 58, 82 may be any suitable magnet, and may include, but are not limited to, rubberized magnets, rubber coated magnets, plastic coated magnets, neodymium magnets coated in rubber or plastic. The rubber or plastic coating on the magnets will protect the vivarium walls from scratching and other damage. There may be multiple sets of magnets 58,82 along the length and or height of the coral 14 in order to provide more force to hold up the coral shelf.

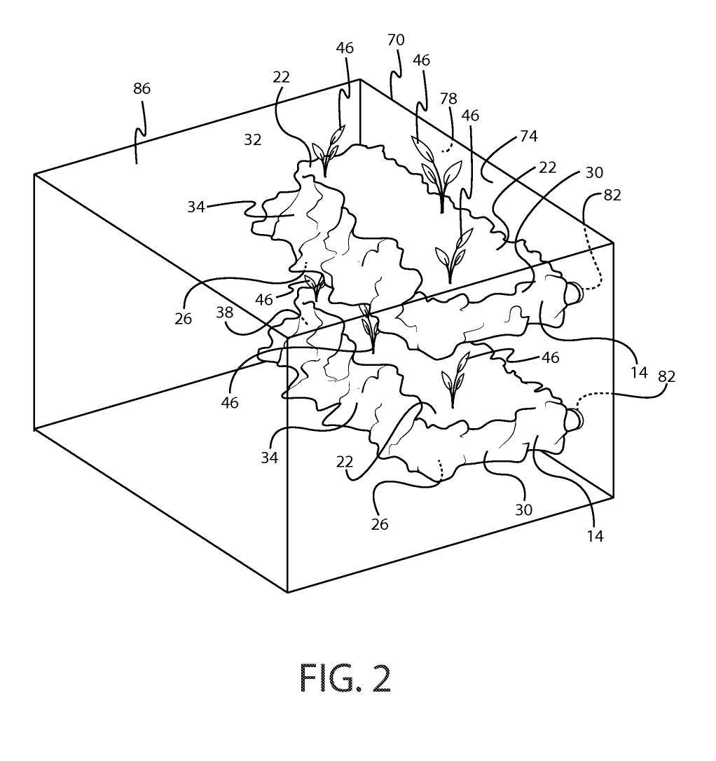

FIG. 2 is a perspective view of a vivarium 86. In this embodiment, two corals 14 are attached to the inner side 74 of a rear vivarium wall 70. The magnets 82 located on the outer side 78 are partially visible. Depending on the size of the vivarium more or less than two corals may be attached to the rear vivarium wall 70. In other embodiments, one or more corals configured either in shelf or flat wall shapes may be attached to the side and front walls of the vivarium.

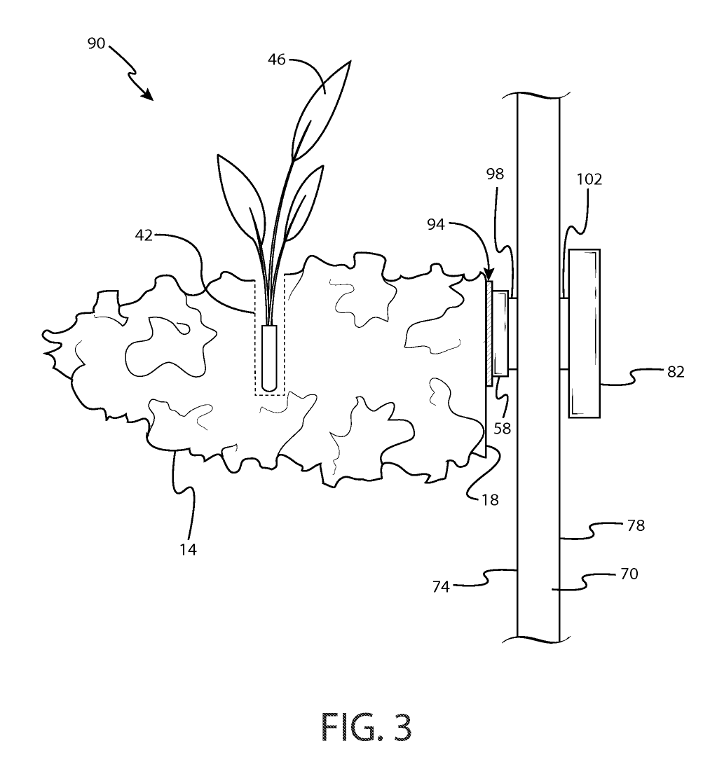

FIG. 3 is side view of another embodiment of a vivarium wall device system 90. A plastic glue disc 94 is attached to the glass-side surface 18 of the coral 14 using a suitable adhesive, such as, but not limited to a marine adhesive, or a marine silicone. Attached to the other side of the plastic glue disc 94 is an inside magnet 58. The inside magnet 58 may be a marine waterproof coated magnet. In one embodiment, the magnet attaches to the disc 94 with a resin epoxy adhesive. One reason for using epoxy is that epoxy generally will not adhere to the rock and silicone generally will not adhere to the magnet properly. The disc 94 also provides a flat surface for both attachments. The disc 94 replaces the screw 54 in the embodiment shown in FIG. 1, thus making for a simpler design. The inside magnet 58 may be attached to the plastic glue disc 94 via any suitable adhesive, including, but not limited to a marine adhesive. Attached to the other side of the inside magnet 58 (opposite the plastic glue disc side) is a plastic spacer 98. The plastic spacer 98 is attached to the magnet 58 via any suitable adhesive, including but not limited to a marine adhesive or resin epoxy adhesive. The plastic spacers may allow for use of adhesives compatible with each respective surface. The plastic spacers protect the surface of the inner side 74 of the vivarium wall 70 and gives a generally calculable coefficient of surface friction between the spacer 98 and vivarium wall 70. In this embodiment, there is no glue or adhesive between the plastic spacer 98 and the inner side 74 of the vivarium wall 70. An outside magnet 82 is located near the outer side 78 of the vivarium wall 70. The inner surface of the outside magnet 82 is attached to an outer plastic spacer 102. The outside magnet 82 may be attached to the plastic spacer 102 via any suitable adhesive, including but not limited to a marine adhesive or resin epoxy adhesive. The outside magnet 82 is in magnetic attraction with the inside magnet 58, and it is the magnetic attraction between the two magnets 58, 82 and the coefficient of friction between the plastic spacers 98, 102 and the vivarium wall 70 that generally hold the coral 14 in place relative to the wall 70. In another embodiment, an adhesive may be used to attach the plastic spacers 98, 102 to the vivarium wall 70. The coral may vary from six inches in any direction to eighteen inches in any direction. The magnets 58, 82 may, in one embodiment, be sized at about one inch square and about ⅛^{th} inch in thickness covered with a marine grade sealer paint or vinyl. There may be multiple sets of magnets 58, 82 along the length and or height of the coral 14 in order to provide more force to hold up the coral shelf

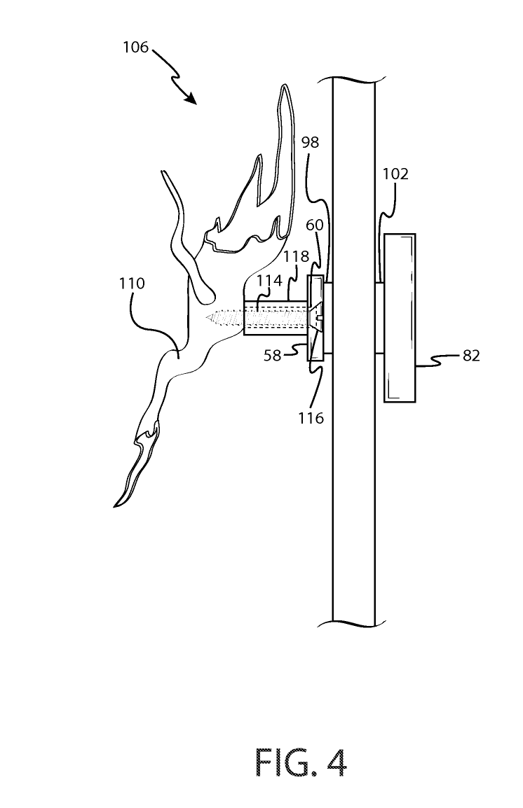

FIG. 4 is a cross-sectional view of another embodiment 106 of the vivarium wall device system. In this embodiment, wood piece 110 is used as the element to hang on the vivarium wall 70. The wood piece 110 may have a shelf-like shape, similar to the coral 14, or as shown, be more decorative and without a shelf-like shape. The wood piece may be freshwater compatible or may be salt water compatible. The wood piece 110 may be custom cut, or may be simply found driftwood. Wood piece 110 may be selected from any suitable type of wood, including but not limited to Manzenita or Malaysian Driftwood. The wood piece 110 may vary from six inches in any direction to eighteen inches in any direction. A screw 114 within a hollow jacket 118 is used to attach the wood piece 110 to a magnet 58. The screw 114 is screwed into the wood piece 110 until wood piece 110 is generally flush with the plastic jacket 118. The screw 114 may be any suitable type of screw, including but not limited to a non-ferrous screw. The jacket 118 may be any suitable type of jacket, including but not limited to a round plastic jacket. The magnet 58 has a hole 60 that allows the screw 114 to slide through until the head 116 of the screw 114 (which is bigger than the hole) is stopped. The hole may unthreaded in one embodiment. In another embodiment, the hole may be threaded, and the screw is screwed into the hole in magnet. The hole 60 may be countersunk so that the screw head 116 is flush with the surface of the magnet 58. The jacket 118 is slid onto the screw after the screw is attached to the magnet, then the screw is screwed into the wood piece 110. Attached to the other side of the magnet 58 is a plastic spacer 98. The plastic spacer 98 is attached to the magnet 58 via any suitable adhesive, including but not limited to a marine adhesive. An outside magnet 82 is located near the outer side 78 of the vivarium wall 70. The inner surface of the outside magnet 82 is attached to an outer plastic spacer 102. The outside magnet 82 may be attached to the plastic spacer 102 via any suitable adhesive, including but not limited to a marine adhesive. The outside magnet 82 is in magnetic attraction with the inside magnet 58, and it is the magnetic attraction between the two magnets 58, 82 and the coefficient of friction between the plastic spacers 98, 102 and the vivarium wall 70 that generally hold the wood piece 110 in place relative to the wall 70. There may be multiple sets of magnets 58,82 along the length and or height of the coral 14 in order to provide more force to hold up the wood piece 110.

The disclosed device has many advantages. The disclosed vivarium wall attachable coral system will not scratch or damage the vivarium glass. The device provides natural support for industry live specimen “frag plugs” without use of artificial supports that cultivate unattractive algae, Growth attachment between the live specimen “frag” onto adjacent natural coral eliminates the need for relocation from unnatural support to natural support upon maturation. The device eliminates the risk of lime contamination from cement artificial rock. The use of rubber magnets protect the vivarium glass, and provide for additional friction to help maintain the positioning of the coral with respect to the vivarium wall. The coral is a natural material that does not look artificial. The Pukani coral is a “dead” coral when harvested and reduces environmental impact to the ocean environment normally associated with “live rock” harvesting. The disclosed system eliminates the need for vertical support, other than the magnets. The entire mounting system is marine compatible and will not deteriorate. Due to the strength of the magnets, and the rubber coated magnets, the coral will not slide down the vivarium wall. For vivarium wall 70 thicknesses above ⅜ of an inch, an additional magnet 82 may be magnetically attached to the surface of the inner magnet 58 for added pulling strength. Magnet 82 may have larger pulling strength than magnet 58 to reduce the size of magnet 58 for aesthetical reasons.

There may be water circulation all around the coral when the invention is used in an aquarium. The disclosed system is not limited to use with only aquariums, the system may also be used with terrariums and other types of vivariums.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A vivarium wall device system comprising:
a piece of coral, the piece of coral having a glass-side surface, upper surface, lower surface, and three side surfaces, and where the glass-side surface is generally flat and regular;
a vivarium wall attachment means comprising:
a first inside magnet, generally permanently attached to the glass-side surface;
a first outside magnet, configured to be removeably and magnetically attachable to the first inside magnet;
wherein when the first inside magnet is configured to be located inside the vivarium and magnetically attach to a first outside magnet located outside of the vivarium, and wherein the magnetic attraction occurs across a vivarium wall, and the coefficient of friction of the vivarium wall and the magnetic force tend to hold the piece of coral in place on the vivarium wall.

2. The vivarium wall device of claim 1, wherein there is a gap between the vivarium wall and the piece of coral.

3. The vivarium wall device system of claim 1, further comprising:
a plastic glue disc attached to the glass-side surface via an adhesive and attached to a first side first of the inside magnet via an adhesive;
an inside plastic spacer attached, via an adhesive, to a second side of the inside magnet;
an outside plastic spacer attached to the first outside magnet via an adhesive,
and wherein the inside plastic spacer and outside plastic spacer both abut the vivarium wall.

4. The vivarium wall device system of claim 1, further comprising:
a first hole located in the glass-side surface;
a threaded screw located in the first hole and held in place in the first hole by an adhesive, with the pointed end of the screw extending out of the first hole;
the first inside magnet attached to the threaded screw by being screwed onto the threaded screw.

5. The vivarium wall device system of claim 4, wherein a layer of adhesive is located between the first inside magnet and the glass-side surface and configured to help attach the first inside magnet to the glass side surface.

6. The vivarium wall device system of claim 1, further comprising:
a plug hole located in the upper surface.

7. The vivarium wall device system of claim 1, further comprising:
a plant plug located in the plug hole.

8. The vivarium wall device system of claim 1, further comprising:
a second inside magnet, generally permanently attached to the glass-side surface;
a second outside magnet, configured to be removeably and magnetically attachable to the second inside magnet;
wherein when the second inside magnet is configured to be located inside the vivarium and magnetically attach to a second outside magnet located outside of the vivarium, and wherein the magnetic attraction occurs across a vivarium wall, and the coefficient of friction of the vivarium wall and the magnetic forces tend to hold the piece of coral in place on the vivarium wall.

9. A vivarium wall device system comprising:
a wood piece, the wood piece having a glass-side;
a vivarium wall attachment means comprising:
a first inside magnet, generally permanently attached to the glass-side;
a first outside magnet, configured to be removeably and magnetically attachable to the first inside magnet;
wherein when the first inside magnet is configured to be located inside the vivarium and magnetically attach to a first outside magnet located outside of the vivarium, and wherein the magnetic attraction occurs across a vivarium wall, and the coefficient of friction of the vivarium wall and the magnetic force tend to hold the wood piece in place on the vivarium wall.

10. The vivarium wall device system of claim 9, further comprising:
a hole in the inside magnet configured to hold a threaded screw;
a threaded screw, with a shaft and a screw head, attached to the inside magnet via the hole, and screwed into the glass-side of the wood piece;
a plastic jacket enclosing the screw shaft and located adjacent a first side of the inside magnet and the glass-side of the wood piece.

11. The vivarium wall device system of claim 10, wherein the hole is countersunk so that the screw head is flush with the surface of the inside magnet.

12. The vivarium wall device system of claim 10, further comprising:
an inside plastic spacer attached, via an adhesive, to a second side of the inside magnet;
an outside plastic spacer attached to the first outside magnet via an adhesive,
and wherein the inside plastic spacer and outside plastic spacer both abut the vivarium wall.
